(19) United States
(12) Patent Application Publication
(10) Pub. No.: US 2019/0367092 A1
(43) Pub. Date: Dec. 5, 2019

(54) STEERING DEVICE AND STEERING CONTROL METHOD THEREOF

(71) Applicant: Mando Corporation, Gyeonggi-do (KR)

(72) Inventor: Hyeon HEO, Gangwon-do (KR)

(21) Appl. No.: 16/421,429

(22) Filed: May 23, 2019

(30) Foreign Application Priority Data
May 31, 2018 (KR) 10-2018-0062373

(51) Int. Cl. B62D 15/02; B62D 6/08

(52) U.S. Cl. CPC B62D 15/025; B62D 6/08

(57) ABSTRACT

The present disclosure relates to a steering control device and method including an automatic steering controller configured to generate automatic steering information corresponding to at least one of steering torque information or steering angle information used for controlling a vehicle travelling in an automatic steering mode; a driver steering information detector configured to detect driver steering information generated according to a steering wheel operation of the driver; and an automatic steering mode deactivator configured to determine the deactivation of the automatic steering mode based on the driver steering information and the difference value between the driver steering information and the automatic steering information if the driver steering information is detected during the automatic steering mode, and to deactivate the automatic steering mode if the deactivation of the automatic steering mode is determined. According to the present disclosure, the driver can recognize the deactivation of the automatic steering mode regardless of the direction of the automatic steering information and the direction of the driver steering information.

### CROSS REFERENCE TO RELATED APPLICATION

This application claims priority from Korean Patent Application No. 10-2018-0062373, filed on May 31, 2018, which is hereby incorporated by reference for all purposes as if fully set forth herein.

### BACKGROUND OF THE INVENTION

### 1. Field of the Invention

The present disclosure relates to a steering device and a steering control method using the steering device.

### 2. Description of the Prior Art

In general, a steering apparatus of a vehicle is a device for assisting a driver to travel the vehicle in the desired direction by arbitrarily changing the center of pivot of the vehicle's wheel. That is, the driver may intervene in the steering of the vehicle by operating the steering device of the vehicle.

Recently, the research on autonomous driving techniques for providing convenience to the driver by minimizing the driver's intervention in the steering of the vehicle has been actively conducted. For example, there is a technology of an automatic steering mode in which the vehicle automatically performs steering.

However, even if the driver's intervention on the steering of the vehicle is minimized, the driver's active intervention may be required to cope with the emergency situation. In this situation, it is necessary that the behavior of the vehicle is controlled stably according to the intervention of the driver.

In this case, in order to prevent overlapping control between the vehicle and the driver, the automatic steering mode may be deactivated if the driver intervenes on the behavior of the vehicle, and the driver directly recognizes the deactivation of the automatic steering mode by controlling the behavior of the vehicle.

However, depending on whether the steering direction in the automatic steering mode coincides with the steering direction in the driver intervention, there may be a difference in the feeling of deactivation of the automatic steering mode felt by the driver.

Due to this difference in the feeling of the deactivation of the automatic steering mode, the driver may feel a sense of difference in the steering of the vehicle.

### SUMMARY OF THE INVENTION

For this background, the present disclosure may provide the steering device and the steering control method capable of accurately recognizing the deactivation of an automatic steering mode regardless of the steering direction when the vehicle automatically performs steering and the steering direction by the driver.

The present disclosure may also provide the steering device and a steering control method that minimizes a sense of difference caused by a sudden change in torque in the case that the driver intervenes in the steering of the vehicle during the operation of the automatic steering mode.

In accordance with an aspect of the present disclosure, there is provided a steering device including: an automatic steering controller configured to generate automatic steering information corresponding to at least one of steering torque information or steering angle information used for controlling a vehicle travelling in an automatic steering mode; a driver steering information detector configured to detect driver steering information generated according to a steering wheel operation of the driver; and an automatic steering mode deactivator configured to determine the deactivation of the automatic steering mode based on the driver steering information and the difference value between the driver steering information and the automatic steering information if the driver steering information is detected during the automatic steering mode, and to deactivate the automatic steering mode if the deactivation of the automatic steering mode is determined.

In accordance with another aspect of the present disclosure, there is provided a steering control method including: generating automatic steering information corresponding to at least one of steering torque information or steering angle information used for controlling a vehicle travelling in an automatic steering mode; detecting driver steering information generated according to a steering wheel operation of the driver; and determining the deactivation of the automatic steering mode based on the driver steering information and the difference value between the driver steering information and the automatic steering information if the driver steering information is detected during the automatic steering mode, and deactivating the automatic steering mode if the deactivation of the automatic steering mode is determined.

As described below, according to the present disclosure, it is possible to provide the steering device and the steering control method capable of accurately recognizing the deactivation of an automatic steering mode regardless of the steering direction when the vehicle automatically performs steering and the steering direction by the driver.

In addition, according to the present disclosure, it is possible to provide the steering device and a steering control method that minimizes a sense of difference caused by a sudden change in torque in the case that the driver intervenes in the steering of the vehicle during the operation of the automatic steering mode.

### BRIEF DESCRIPTION OF THE DRAWINGS

FIG. 1 is a diagram for explaining the automatic steering mode according to the present disclosure;

FIG. 2 is a diagram illustrating the configuration of the steering device according to the present disclosure;

FIG. 3 is a flow chart illustrating the method of operating the steering device according to the present disclosure;

FIG. 4 is a graph illustrating the reference time corresponding to the difference value between driver steering information and automatic steering information; and

FIG. 5 is a flowchart illustrating the steering control method according to the present disclosure.

### DETAILED DESCRIPTION OF THE EXEMPLARY EMBODIMENTS

In the following description of examples or embodiments, reference will be made to the accompanying drawings in which it is shown by way of illustration specific examples or embodiments that can be implemented, and in which the same reference numerals and signs can be used to designate the same or like components even when they are shown in different accompanying drawings from one another.

Further, in the following description of the present disclosure, detailed descriptions of well-known functions and components incorporated herein will be omitted when it is determined that the description may make the subject matter in some embodiments of the present disclosure rather unclear.

The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”

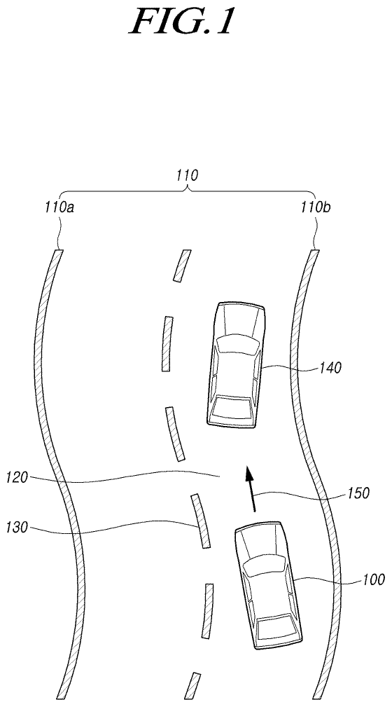

FIG. 1 is a diagram for explaining the automatic steering mode according to the present disclosure.

Referring to FIG. 1, the automatic steering mode according to the present disclosure may mean a mode in which the host vehicle 100 automatically performs the steering. That is, if the host vehicle 100 performs the automatic steering mode, the automatic steering information according to the traveling direction 150 and the traveling direction 150 of the host vehicle 100 may be determined based on information transmitted and received from the sensor (camera, radar, etc.) included in the host vehicle 100. The host vehicle 100 performing the automatic steering mode may automatically perform the steering according to the determined traveling direction 150 and the automatic steering information.

In the disclosure, the automatic steering mode may include an autonomous driving mode in which the host vehicle 100 can travel without the driver's operation, and a semi-autonomous driving mode in which a part of the automatic driving of the host vehicle 100 is assisted by the driver's operation. The automatic steering mode described below may mean the autonomous driving mode in which the host vehicle 100 automatically steers by itself without the intervention of the driver for convenience of explanation.

For example, the automatic steering mode may mean a mode in which the host vehicle 100 automatically performs steering using an angle overlay function and/or a torque overlay function, but the present invention is not limited thereto.

The host vehicle 100 equipped with the automatic steering mode according to the present disclosure may extract road information about the lane 110 on the road, the boundary lane 130, and the like using the image information received through the camera sensor. The host vehicle 100 may generate the traveling direction 150 based on the road information, and to automatically travel in the generated traveling direction.

The host vehicle 100 equipped with the automatic steering mode according to the present disclosure also may determine the traveling route 120 of the subject vehicle 100 by using the input information on the destination input by the driver and the current position information of the host, and may automatically travel without departing from the traveling route 120.

The host vehicle 100 performing the automatic steering mode may determine the traveling direction 150 and the automatic steering information for the host vehicle 100 by using the road information and the traveling route 120 of the host vehicle 100 so as not to depart from the traveling route 120, the boundary lane 130 and the lane 110.

However, an unexpected emergency situation may occur during the host vehicle 100 is traveling in the automatic steering mode, and in such a situation, it may be required for the driver of the host vehicle 100 to manually control the steering of the host vehicle 100.

In the case that the driver of the host vehicle 100 manually controls the steering of the host vehicle 100, the automatic steering mode may be deactivated for preventing duplicated steering control of the host vehicle 100. At this case, the driver of the host vehicle 100 should be able to recognize whether or not the automatic steering mode is deactivated.

As a method of deactivating the automatic steering mode, the automatic steering mode may be deactivated in the case that the driver grasps the steering wheel and holds the steering wheel for a predetermined reference time or longer with a value equal to or higher than a predetermined torque.

The emergency situation that may occur during the traveling of the host vehicle 100 in the automatic steering mode will be described in detail with reference to FIG. 1. In the case such an emergency situation occurs, the automatic steering mode may be deactivated and the host vehicle can be shifted to the manual steering mode.

For example, if the possibility of collision with the host vehicle 100 occurs due to a sudden deceleration of the preceding vehicle 140, the host vehicle 100 may perform the steering control in the left direction to move to the left path of the traveling route 120 by the automatic steering mode.

At this case, if the driver of the host vehicle 100 determines that the avoidance steering angle as the automatic steering information by the automatic steering mode is not sufficient to avoid a collision with the preceding vehicle 140, the driver may control the steering of the host vehicle 100 directly by manually operating the steering wheel.

If the driver of the host vehicle 100 intervenes the steering of the host vehicle 100 as above, the automatic steering mode may be deactivated. In addition, if the automatic steering mode is deactivated, the driver of the host vehicle 100 should be able to recognize whether the automatic steering mode is deactivated or whether the driver of the host vehicle 100 directly controls the steering of the host vehicle 100.

In this case, if the steering direction by the automatic steering mode and the manual steering direction by the driver of the host vehicle 100 are the same direction (left or right turn), it may be difficult to recognize whether the automatic steering mode is deactivated unlike the case in which the two steering directions are opposite to each other.

Therefore, if the driver of the host vehicle 100 rotates the steering wheel with a larger torque or with a large steering angle to confirm whether the automatic steering mode is deactivated, the host vehicle 100 may cause an accident by cross the left lane 110a.

In order to solve these problems, the present disclosure to be described below is directed to an apparatus and a method capable of recognizing the deactivation of the automatic steering mode by the driver regardless of the automatic steering direction by the automatic steering information and the manual steering direction by the driver.

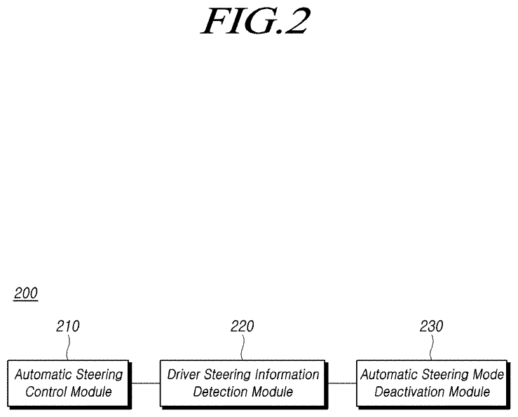

FIG. 2 is a diagram illustrating the configuration of the steering device according to the present disclosure.

Referring to FIG. 2, the steering devices 200 according to the present disclosure may include the automatic steering control module 210, the driver steering information detection module 220, the automatic steering mode deactivation module 230, and the like. In this specification, the automatic steering control module 210, the driver steering information detection module 220 and the automatic steering mode deactivation module 230 may also be expressed as the term of the automatic steering controller, the driver steering information detector, and the automatic steering mode deactivator, respectively.

The automatic steering control module 210 may generate automatic steering information including at least one of steering torque information and steering angle information in order to control the traveling of the host vehicle in the automatic steering mode.

Specifically, the automatic steering control module 210 may generate, as automatic steering information, a steering torque required for controlling the traveling in the automatic steering mode. Alternatively, the automatic steering control module 210 may generate, as automatic steering information, the steering angle required for controlling the traveling in the automatic steering mode.

Here, the steering torque information may be defined as torque information necessary for the host vehicle to automatically perform the steering. That is, the steering torque information may include a torque value according to the torque overlay. This steering torque information may be generated by the automatic steering control module 210 or received from an electronic control unit (not shown).

Referring to FIG. 1, for example, the automatic steering control module 210 may extract information on the lane 110 and the boundary lane 130 from the image information obtained from the camera, and may generate the steering torque information required for the host vehicle 100 to travel between the lane 110 and the boundary lane 130 by using the curvature of each of the lane 110 and the boundary lane 130.

Alternatively, if the steering torque information generated by the electronic control unit (not shown) mounted on the host vehicle 100 is received, the automatic steering control module 210 may determine the steering torque value indicated by the steering torque information as the automatic steering information, and may calculate the motor control current and provide the motor control current to the steering motor so that the steering torque value as the automatic steering information is applied to the steering motor. Meanwhile, the steering angle information may be defined as the steering angle of the host vehicle with respect to the traveling direction required for the host vehicle to automatically travel according to automatic steering mode. That is, the steering angle information may include an automatic steering angle value of the host vehicle 100 according to the angle overlay in the automatic steering mode.

Referring to FIG. 1, for example, the automatic steering control module 210 may extract the road information from the image information obtained from the camera, may generate the traveling route 120 of the host vehicle based on the road information, may generate and change the steering angle information according to the traveling route 120, and may generate the steering torque information as the automatic steering information based on the torque conversion algorithm according to the changed steering angle information.

Alternatively, if the steering angle information generated by the electronic control unit (not shown) is received, the automatic steering control module 210 may be operable to calculate automatic steering information required for the vehicle to travel at the corresponding angle using the steering motor, calculate the motor control current corresponding to the automatic steering information and apply the motor control current to the steering motor.

The automatic steering mode may be set according to the input signal of the driver. Further, the automatic steering mode may be set or deactivated before or during running of the host vehicle 100.

In the case that the automatic steering mode is deactivated, the steering motor can provide the steering assist force in accordance with the steering control of the driver to determine the traveling direction 150 of the host vehicle 100.

In the automatic steering mode, the traveling direction of the vehicle can be determined using only the torque output by the steering motor.

The driver steering information detection module 220 may detect the driver steering information generated according to the driver's steering wheel operation.

The driver steering information may include at least one of driver steering torque information or driver steering angle information. Here, the driver steering torque information and the driver steering angle information may mean information about the steering torque and the steering angle generated by the steering wheel operation of the driver.

The detection of driver steering information may be implemented in various manners. For example, if the steering wheel (not shown) is rotated by the driver, the torque sensor included in the host vehicle 100 may detect the driver steering torque information as the steering wheel rotates. For example, if the steering wheel is rotated by the driver, the steering angle sensor included in the host vehicle 100 may detect the driver steering angle information according to the rotation of the steering wheel.

In the case that the driver steering information is detected in the automatic steering mode, the automatic steering mode deactivation module 230 may determine whether or not the automatic steering mode is to be deactivated based on the detected driver steering information and the difference value between the driver steering information and the automatic steering information. Also, if the deactivation of the automatic steering mode is determined, the automatic steering mode deactivation module 230 may deactivate the automatic steering mode.

In the automatic steering mode, the automatic steering mode deactivation module 230 may determine the steering intention of the driver by using the driver steering information detected according to the driver steering wheel operation and the information about the holding time at which the detected driver steering information is maintained, and may determine whether to deactivate the automatic steering mode by using the information.

Here, the hold time may mean the time at which the detected driver steering information is maintained.

As a method of determining the steering intention of the driver, for example, a driver's steering wheel on/off detection (HOD) method may be used. That is, in the case that the driver steering torque information and the driver steering angle information generated by the driver correspond to the reference value corresponding to the specific level among the reference values corresponding to the plurality of levels set according to the HOD method, it can be determined that the driver has steering intention.

In one example, a plurality of levels may be determined from 1 to 3, a first reference value corresponding to level 1 may be set to a torque value from 0 to 0.5 Nm, a second reference value corresponding to level 2 may be set to a torque value from 0.5 Nm to 1 Nm, and a third reference value corresponding to the level 3 may be set to a torque value of 1 Nm or more and less than 2.7 Nm. At this case, if it is assumed that the driver has steering intention at the level 3, if the driver steering torque information is 2.5 Nm, it may be determined that the driver has the steering intension, but is not limited thereto.

Here, in determining the deactivation of the automatic steering mode, the driver's steering torque may be generated by the driver accidentally operating the steering wheel, or when the vehicle vibrates, and the deactivation of the automatic steering mode may be erroneously determined at this cases. Therefore, it is necessary to specifically classify the criteria to solve errors of the automatic steering mode deactivation.

For example, the automatic steering mode deactivation module 230 may determine the deactivation of the automatic steering mode by determining whether the driver steering torque information detected according to the driver's steering wheel operation in the automatic steering mode is equal to or greater than the reference torque, and by determining whether the holding time at which the driver steering torque information is maintained at the reference torque or more is equal to or longer more than a predetermined reference time.

Here, the reference torque may be a predetermined value for determining the steering intention of the driver. As described above, the reference torque may be a reference value corresponding to the specific level among the reference values corresponding to the plurality of levels set according to the HOD method. For example, if the level is classified into one to four levels according to the HOD method, the reference torque may be a third reference value corresponding to level 3. However, the present invention is not limited thereto.

Meanwhile, when the driver operates the steering wheel in the automatic steering mode, the feeling of deactivation the automatic steering mode felt by the driver may be changed depending on the steering direction of the steering wheel.

If the direction of the detected driver steering information is the same as the direction of the automatic steering information, the driver may not be aware of the deactivation of the automatic steering mode.

On the other hand, if the direction of the detected driver steering information is opposite to the direction of the automatic steering information, the driver can easily recognize the deactivation of the automatic steering mode.

Therefore, it is necessary to set the reference time according to the direction of the detected driver steering information.

Here, the reference time may be set based on the difference value between the automatic steering information and the driver steering information.

Here, the reference time may be calculated by first setting a first reference time, by setting a weight corresponding to the difference value between the detected driver steering information and the automatic steering information, and by adding a value obtained by multiplying the first reference time by a weight to the first reference time.

For example, the automatic steering mode deactivation module 230 may determine the weight corresponding to the difference value, if the difference value is changed, may determine the second reference time by reflecting the weight corresponding to the changed difference value to the first reference time, and may determine whether of the deactivation of the automatic steering mode by comparing the holding time with the second reference time.

In another example, the automatic steering mode deactivation module 230 may determines whether of the deactivation of the automatic steering mode based on a predetermined first reference time, and if the difference value decreases, may determine the deactivation of the automatic steering mode based on the second reference time weighted at the first reference time. Here, the second reference time may be a time longer than the first reference time.

As another example, the automatic steering mode deactivation module 230 may deactivate the automatic steering mode if the detected driver steering information continues for a predetermined reference time or more. At this time, the reference time in the case that the direction of the detected driver steering information is the same as the direction of the automatic steering information may be set longer than the reference time in the case that the direction of the driver steering information is opposite to the direction of the automatic steering information.

There may be various methods for deactivating the automatic steering mode. For example, in deactivating the automatic steering mode, the automatic steering information applied in the automatic steering mode may be ramped down to a value of 0 in a sequential manner during a predetermined deactivation time.

Here, the deactivation time may be the time taken for the automatic steering information to decrease from a certain value to zero, and the deactivation time may be controlled by the setting, the design, the travel condition and the like.

For example, if the automatic steering mode deactivation module 230 determines to deactivate the automatic steering mode, the automatic steering mode deactivation module 230 may ramp down the steering torque value included in the automatic steering information of 2.5 Nm to zero for the predetermined reference time of 150 ms after the reference time of 100 ms. However, the present embodiment is not limited thereto.

The steering device 200 or the automatic steering control module 210, the driver steering information detection module 220 and the automatic steering mode deactivation module 230 included in the steering device may be may be implemented as a steering control apparatus for controlling the steering of the host vehicle 100 or an a partial modules of an ECU therefor.

The steering device or the ECU may include a processor, a storage such as and a memory and a computer program capable of performing a specific function. The automatic steering control module 210, the driver steering information detection module 220 and the automatic steering mode deactivation module 230 may be implemented as software modules capable of performing their respective functions.

The steering device 200 according to the present embodiment may be implemented as a computer system connected to the antenna system. The computer system may include one or more element of processors, a memory, a storage, a user interface input and a user interface output, which are capable of communicating with one another via a communication bus.

In addition, the computer system may also include a network interface for connecting to a network.

The processor may be a CPU or a semiconductor device that executes processing instructions stored in memory and/or in the storage. Memory and storage may include various types of volatile/non-volatile storage media. For example, the memory may include ROM and RAM.

In the steering device having such a hardware configuration, a software or a program for performing the functions of the automatic steering control module 210, the driver steering information detection module 220 and the automatic steering mode deactivation module 230 may be stored or installed in the memory or the storage unit, and may be executed by the processor

More particularly, the computer system for performing the controlling of the steering device 200 according to the present embodiment may execute software stored in a memory so as to generate the automatic steering information, detect the driver steering information and deactivate the automatic steering mode based on the automatic steering information and the driver steering information as above.

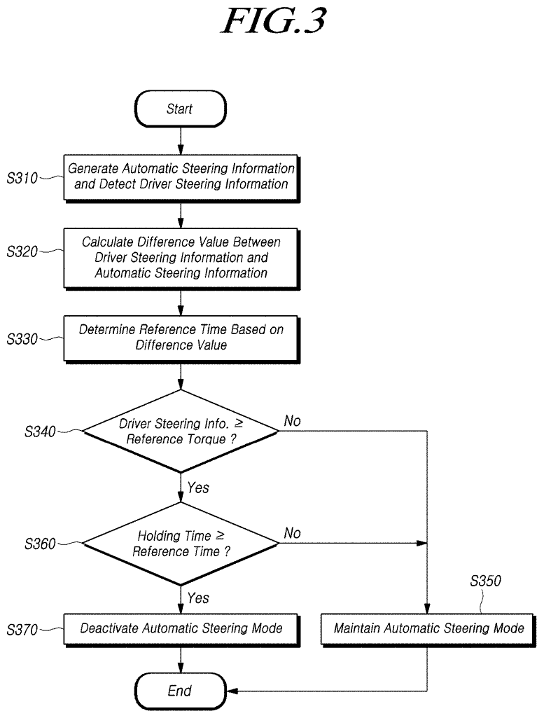

The control method of the steering device 200 according to the present disclosure will be described in detail with reference to FIG. 3. Hereinafter, it is assumed that the automatic steering information is referred to as steering torque information, and the driver steering information includes the driver steering torque information generated according to the driver's steering wheel operation.

FIG. 3 is a flow chart illustrating the method of operating the steering device according to the present disclosure.

Referring to FIG. 3, the automatic steering control module 210 may receive the steering torque information and generate automatic steering information corresponding to the received steering torque information (S310).

If the driver operates the steering wheel, the driver steering information detection module 220 may detect the driver steering information generated by the operation of the steering wheel through the torque sensor (S310).

The generation of the automatic steering information and the detection of the driver steering information may be simultaneously performed as shown in FIG. 3, but the present embodiment is not limited thereto.

The automatic steering mode deactivation module 230 may calculate the difference value between the detected driver steering information and the automatic steering information (S320).

The automatic steering mode deactivation module 230 may set the reference time corresponding to the difference value in advance based on the difference between the detected driver steering information and the automatic steering information (S330).

Here, the automatic steering mode deactivation module 230 may preset the reference torque to be compared with the detected driver steering information.

The automatic steering mode deactivation module 230 may determine whether the detected driver steering information is equal to or greater than a preset reference torque (S340). Here, the reference torque may be determined to be 2.7 Nm, for example. However, the present embodiment is not limited thereto.

If the driver steering information is less than the reference torque, the automatic steering control module 210 may continue to maintain the automatic steering mode (S350).

If the driver steering information is equal to or greater than the reference torque, the automatic steering mode deactivation module 230 may determine whether the holding time at which the detected driver steering information is maintained equal to or greater than the reference torque is equal or greater than the reference time (S360).

If the detected driver steering information is equal to or greater than the reference torque and the holding time at which the driver steering information is maintained at the reference torque or more is equal to or longer than the reference time, the automatic steering mode deactivation module 230 may deactivate the automatic steering mode (S370).

For example, if the driver steering information is 2.7 Nm or more and the holding time at which the driver steering information is maintained at 2.7 Nm or more is 100 ms or more, which is the reference time, the automatic steering mode is deactivated.

Here, the reference time may be preset according to the difference value between the driver steering information and the automatic steering information through experiments, algorithms and simulations.

For example, if the difference value between the detected driver steering information and the automatic steering information is 1 Nm, the reference time may be set to 135 ms. If the difference value between the driver steering information and the automatic steering information is 5 Nm, the reference time may be set to 100 ms. However, the present embodiment is not limited thereto.

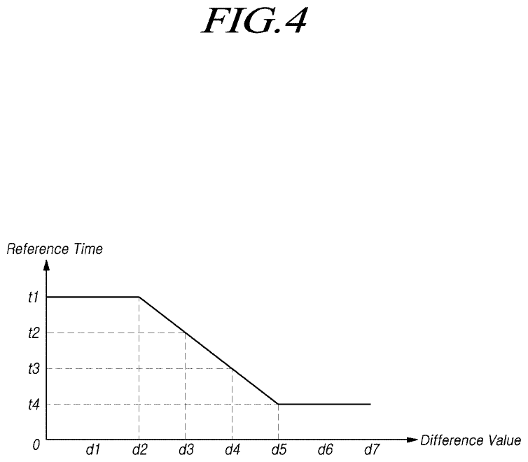

Hereinafter, the relationship between the reference time and the difference value between the detected driver steering information and the automatic steering information will be described with reference to FIG. 4.

FIG. 4 is a graph illustrating the reference time corresponding to the difference value between driver steering information and automatic steering information.

As described above, the driver can feel the deactivation of the automatic steering mode differently depending on the direction of the driver steering information and the direction of the automatic steering information.

The automatic steering mode deactivation module 230 may be configured to determine the reference time based on the difference value between the driver steering information and the automatic steering information so that the driver can sufficiently feel or recognize the deactivation of the automatic steering mode regardless of whether the directions of the driver steering information and the automatic steering information are the same or not.

That is, since the torque direction is reflected by the sign of the torque value, if the direction of the driver steering torque information is the same as the direction of the automatic steering torque information, the difference value between the two torque information may become relatively small. In this case, the automatic steering mode deactivation module 230 may set the reference time relatively long.

On the other hand, if the direction of the driver steering torque information is opposite to the direction of the automatic steering torque information, the difference value of the two torque information may be a relatively large value. In this case, the automatic steering mode deactivation module 230 may set the reference time relatively short.

Therefore, the reference time may decrease as the difference value increases, and may increase as the difference value decreases. For example, the reference time may be inversely proportional to the difference value between the detected driver steering information and the automatic steering information, but is not limited thereto.

Referring to FIG. 4, for example, if the direction of the driver steering information and the direction of the automatic steering information are the same, the difference value of the two torque values may be d3. In this case, the reference time corresponding to the difference value d3 may be determined as t2.

In another example, if the direction of the driver steering information is opposite to the direction of the automatic steering information, the difference value between the two torque values may be d4. In this case, the reference time corresponding to the difference value d4 may be determined as t3.

Here, for convenience of calculation, the difference value of the two torque values may be the absolute value of the difference between the two torque values.

The reference time may be determined as the first time corresponding to the first threshold value if the difference value is equal to or less than the first threshold value.

For example, if the first threshold value is d2 and the first time corresponding to the first threshold value d2 is t1 and the difference value is less than the first threshold value d2, the reference time may be determined to be the first time t1 regardless of the magnitude of the difference value.

Also, the reference time may be determined as the second time corresponding to the second threshold value if the difference value is equal to or greater than the second threshold value.

For example, if the second threshold is d5 and the second time corresponding to the second threshold d5 is t4 and the difference is equal to or greater than the second threshold d2, the reference time may be determined to be the second time t4 regardless of the magnitude of the difference value.

Here, the difference values d1, d2, d3, d4, d5, and d6 and the reference time t1, t2, t3, and t4 can be set to specific numerical values. For example, d1, d2, d3, d4, d5 and d6 may be determined as 0.5 Nm, 1 Nm, 1.5 Nm, 2 Nm, 2.5 Nm and 3 Nm, and t1, t2, t3, and t4 may be determined as 150 ms, 135 ms, 120 ms, 110 ms, 105 ms, and 100 ms, but the present embodiment is not limited thereto.

Meanwhile, the first reference time may be a value set based on in the case that the magnitude of the driver steering torque is equal to the magnitude of the automatic steering torque. For example, if the magnitude of the driver steering torque indicated by the driver steering information and the magnitude of the automatic steering torque indicated by the automatic steering information are the same, the first reference time may be determined as t1 since the difference value is 0 and the reference time corresponding to the difference value 0 is t1.

In this case, if the difference value increases, the automatic steering mode deactivation module 230 may deactivate the automatic steering mode depending on the second reference time determined by applying the weight of 0 to 1 to the first reference time. For example, if the first reference time is t1, the automatic steering mode deactivation module 230 may calculate the second reference values t2-t4 by multiplying the first reference time by a weight of 0 to 1 as the difference value increases from d1 to d7.

Here, the second reference time may be determined as a value that is equal to or greater than a third reference time that is reduced by a predetermined value from the first reference time, and is equal to or smaller than the first reference time. For example, if the first reference time is t1 and the third reference time is t4, the second reference time may be a value included in a range between t4 and t1.

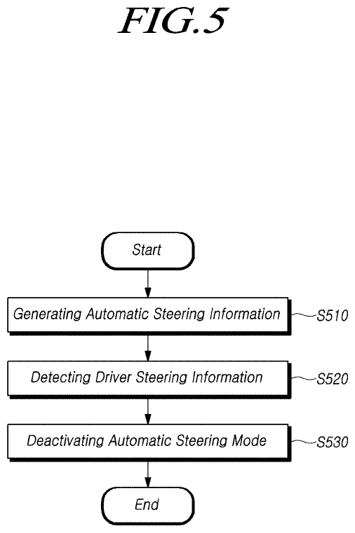

A steering control method capable of performing the functions according to the present disclosure described above will be briefly described with reference to FIG. 5.

FIG. 5 is a flowchart illustrating the steering control method according to the present disclosure.

Referring to FIG. 5, the steering control method according to the present disclosure may include the step S510 of generating automatic steering information corresponding to at least one of received steering torque information or steering angle information to control the vehicle traveling in the automatic steering mode, the step S520 of detecting driver steering information generated in accordance with the driver's steering wheel operation, and the step S530 of determining whether of the deactivation of the automatic steering mode based on the detected driver steering information and the difference value between the driver steering information and the automatic steering information if the driver steering information is detected in the automatic steering mode and of deactivating automatic steering mode if the deactivation of the automatic steering mode is determined.

Here, the step S530 of deactivating the automatic steering mode may include the step of deactivating the automatic steering mode if the driver steering torque information is equal to or greater than a reference torque, and the holding time at which the driver steering torque information is maintained at the reference torque or more is equal to or longer more than the reference time determined based on the difference value between the driver steering information and automatic steering information.

Here, the reference time may be determined in inverse proportion to the difference value between the detected driver steering information and the automatic steering information, as described above with reference to FIG. 4.

As described above, according to the present disclosure, it is possible to provide the steering device and the steering control method capable of accurately recognizing the deactivation of an automatic steering mode regardless of the steering direction when the vehicle automatically performs steering and the steering direction by the driver.

In addition, according to the present disclosure, it is possible to provide the steering device and a steering control method that minimizes a sense of difference caused by a sudden change in torque in the case that the driver intervenes in the steering of the vehicle during the operation of the automatic steering mode.

The above description and the accompanying drawings provide an example of the technical idea of the present invention for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims. The scope of protection of the present disclosure should be construed based on the following claims, and all technical ideas within the scope of equivalents thereof should be construed as being included within the scope of the present disclosure. In addition, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A steering device comprising:
an automatic steering controller configured to generate automatic steering information corresponding to at least one of steering torque information or steering angle information used for controlling a vehicle travelling in an automatic steering mode;
a driver steering information detector configured to detect driver steering information generated according to a steering wheel operation of the driver; and
an automatic steering mode deactivator configured to determine whether of the deactivation of the automatic steering mode based on the driver steering information and the difference value between the driver steering information and the automatic steering information if the driver steering information is detected during the automatic steering mode, and to deactivate the automatic steering mode if the deactivation of the automatic steering mode is determined.

2. The steering device of claim 1, wherein the driver steering information includes driver steering torque information generated according to the steering wheel operation of the driver,
wherein the automatic steering mode deactivator deactivates the automatic steering mode if the driver steering torque information is equal to or greater than a reference torque, and the holding time at which the driver steering torque information is maintained at the reference torque or more is equal to or longer more than a reference time determined based on the difference value.

3. The steering device of claim 2, wherein the reference torque is determined as a reference value corresponding to a specific level among reference values corresponding to a plurality of levels set according to a steering wheel on/off detection method (HOD).

4. The steering device of claim 2, wherein the reference time decreases as the difference value increases, and increases as the difference value decreases.

5. The steering device of claim 2, wherein the automatic steering mode deactivator determines a weight corresponding to the difference value, determines a second reference time by reflecting the weight corresponding to the changed difference value to a preset first reference time if the difference value is changed, and determines whether to deactivate the automatic steering mode by comparing the holding time with the second reference time.

6. The steering device of claim 5, wherein the first reference time is a value set based on when the magnitude of a driver steering torque is equal to the magnitude of a steering torque,
wherein the automatic steering mode deactivator determines whether to deactivate the automatic steering mode based on the second reference time to which the weight of 0 to 1 is reflected to the first reference time in the case that the difference value increases.

7. The steering device of claim 6, wherein the second reference time is equal to or greater than a third reference time reduced by a predetermined value from the first reference time, and is equal to or less than the first reference time.

8. The steering device of claim 2, wherein the reference time is determined as a first time value corresponding to a first threshold value if the difference value is equal to or less than the first threshold value, and is determined as a second time value corresponding to a second threshold value if the difference value is equal to or greater than the second threshold value.

9. The steering device of claim 2, wherein the automatic steering mode deactivator decreases the automatic steering information for a predetermined deactivation time after the reference time when determining to deactivate the automatic steering mode.

10. The steering device of claim 9, wherein the automatic steering information is ramped down during the deactivation time.

11. The steering device of claim 1, wherein the automatic steering mode deactivator deactivates the automatic steering mode if the driver steering information is maintained for a predetermined reference time or longer,
wherein the reference time in the case that the sign of the driver steering information is equal to the sign of the automatic steering information is longer than the reference time in the case that the sign of the driver steering information is opposite to the sign of the automatic steering information.

12. A steering control method comprising:
generating automatic steering information corresponding to at least one of steering torque information or steering angle information used for controlling a vehicle travelling in an automatic steering mode;
detecting driver steering information generated according to a steering wheel operation of the driver; and
determining whether the deactivation of the automatic steering mode based on the driver steering information and the difference value between the driver steering information and the automatic steering information if the driver steering information is detected during the automatic steering mode, and deactivating the automatic steering mode if the deactivation of the automatic steering mode is determined.

13. The steering control method of claim 12, wherein the driver steering information includes driver steering torque information generated according to the steering wheel operation of the driver,
wherein deactivating the automatic steering mode if the driver steering torque information is equal to or greater than a reference torque, and the holding time at which the driver steering torque information is maintained at the reference torque or more is equal to or longer more than a reference time determined based on the difference value.

14. The steering control method of claim 13, wherein the reference time decreases as the difference value increases, and increases as the difference value decreases.

15. The steering control method of claim 13, wherein deactivating the automatic steering mode comprises:
determining a weight corresponding to the difference value,
determining a second reference time by reflecting the weight corresponding to the changed difference value to a preset first reference time if the difference value is changed, and
determining whether to deactivate the automatic steering mode by comparing the holding time with the second reference time.

16. The steering control method of claim 15, wherein the first reference time is a value set based on when the magnitude of a driver steering torque is equal to the magnitude of a steering torque,
wherein deactivating the automatic steering mode comprises determining whether to deactivate the automatic steering mode based on the second reference time to which the weight of 0 to 1 is reflected to the first reference time in the case that the difference value increases.
